(19) United States
(12) Patent Application Publication
(10) Pub. No.: US 2019/0320623 A1
(43) Pub. Date: Oct. 24, 2019

(54) CAGE TO TRANSPORT QUEEN HONEYBEES AND HER ATTENDANTS

(71) Applicants: John Allen Sullivan, Walnut Cove, NC (US); Allen Trevor Qualls, Bon Aqua, TN (US); Michael Eugene Gardner, Baxley, GA (US)

(72) Inventors: John Allen Sullivan, Walnut Cove, NC (US); Allen Trevor Qualls, Bon Aqua, TN (US); Michael Eugene Gardner, Baxley, GA (US)

(21) Appl. No.: 16/389,106

(22) Filed: Apr. 19, 2019

Related U.S. Application Data
(60) Provisional application No. 62/660,545, filed on Apr. 20, 2018.

(51) Int. Cl. A01K 49/00

(52) U.S. Cl. CPC A01K 49/00; A01K 53/00

(57) ABSTRACT

A bee transport cage includes an elongated sliding lid, and a cage body with a top opening. A bee, likely the queen honey bee and attendants if desired, are placed within the cage body through an egress door large enough to accept the queen bee. The space within the cage body is a fondant space that the queen bee and/or attendants may consume.

### CROSS-REFERENCE TO RELATED APPLICATION

This application claims the benefit of priority of U.S. provisional application No. 62/660,545 filed on Apr. 20, 2018, the contents of which are herein incorporated by reference.

### BACKGROUND OF THE INVENTION

The current invention relates to devices for transporting honeybees, and more particularly, to a cage to transport queen honeybees and her attendants safely.

According to the United States Department of Agriculture, about 163,000,000 pounds (74,000,000 kg) of honey is produced in the United States each year. In 2016, 162,000,000 pounds of honey were produced, 5% more than the previous year. Thus, the demand for honey keeps growing. Safe transport of queen honeybees is a challenge. Currently, wood is used with screen wire and corks with a strap stapled to the cage. The bees are inserted through a small hole. This is a difficult and time-consuming process.

There exists a need for a simpler queen cage with fewer pieces, quick installation, and simpler release of the queen bee.

### BRIEF DESCRIPTION OF THE DRAWINGS

FIG. 1 is an exploded perspective view of one embodiment of a bee transport cage;

FIG. 2 is one embodiment of a perspective view of the bee transport cage;

FIG. 3 is a side view of one embodiment of a bee transport cage;

FIG. 4 is a top view of one embodiment of the bee transport cage; and

FIG. 5 is one embodiment of a cross section view of the transport cage.

### SUMMARY OF THE INVENTION

A device for holding and/or transporting a queen honey bee includes

an elongated sliding lid, a cage body with a top opening, the elongated lid adapted to slide onto a top of the cage body to seal the top opening of the cage body, a first egress door at a first end of the cage body, and a second egress door at a second end of the cage body. The second door is sized to accept the bee into the cage body.

In one embodiment, the device further includes an elongated strap attached to the cage body.

In one embodiment, the device further includes a plurality of windows on the elongated sliding lid. In one embodiment, the device further includes a plurality of windows on the cage body.

In another embodiment, a space within the cage body includes a space in which fondant is placed. In one embodiment, the cage body is sized to hold at least one bee. In one embodiment, one queen and four workers are transported in the cage.

In one embodiment, the elongated lid slides under tracks along the top opening of the cage body to seal the cage body.

A method of transporting a queen bee in a package of bees includes inserting the queen bee into the device as previously stated and hanging the device by the elongated strap in the package of bees. In one embodiment, up to four worker bees are inserted into the device with the queen.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

As stated above, transport of queen bees and attendants is a difficult and tedious task. The invention claimed here solves this problem.

Broadly, one embodiment of the present invention is a bee transport cage with a two-piece design, which requires very little labor to build and use compared to existing devices. It includes a strap and eliminates the corks and screen of previous designs built into the single unit. Compared to existing devices, the claimed invention has fewer parts, requires much less labor to assemble, and is easier to use.

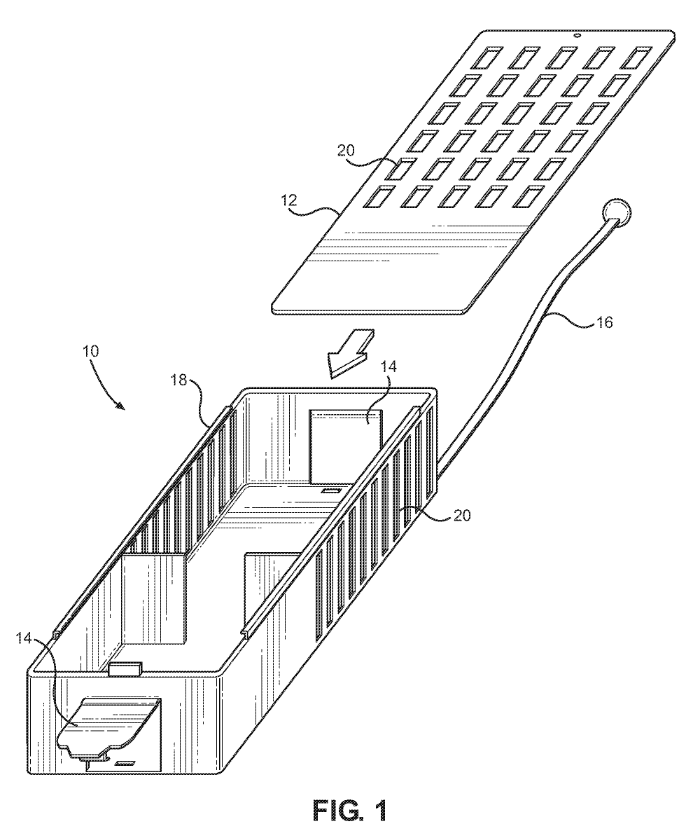

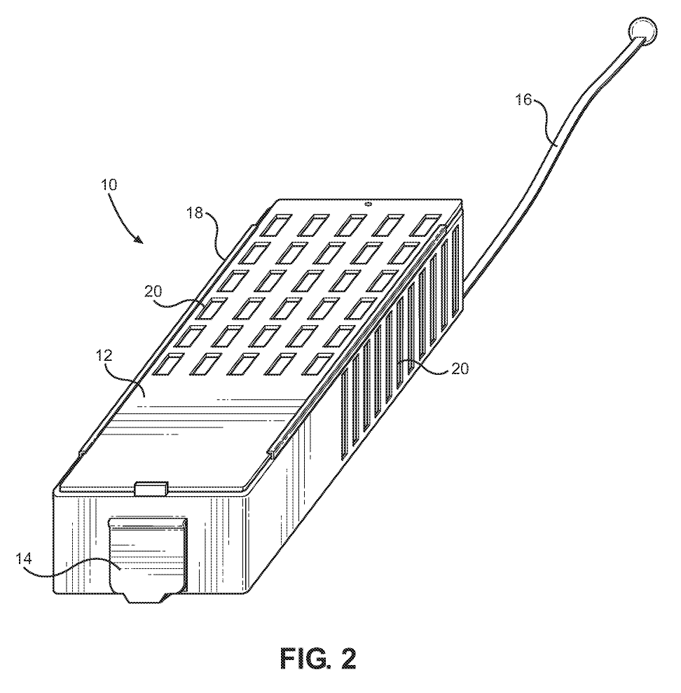

As shown in the embodiment of FIG. 1, a bee transport cage 10 includes a sliding lid 12 with a plurality of windows 20. The cage 10 further includes egress doors 14, a strap 16, a track 18 for the sliding lid 12 to slide under, and second windows 20. A perspective view of the bee transport cage 10 is shown in FIG. 2. In one embodiment, the cage 10 can hold from one to five bees. Many times, the queen is transported with up to four attendants.

In one embodiment, the sliding lid 12 is clear and allows the beekeeper to view the queen and her attendants' health. The lid 12 advantageously slides easily to open the cage, but also secures the cage by sliding under the tracks 18. It is to be understood, however, that the sliding 12 can be secured to the cage 10 by any suitable mechanism. It is also to be understood that in alternative embodiments, the elongated sliding lid 12 may not be transparent.

In one embodiment, the exterior dimensions of the cage 10 are 3″×1¼″× 11/16″. It is to be understood, however, that the dimensions may be any suitable dimensions for holding the bee and/attendants.

In one embodiment, the windows 20 allow the queen bee's pheromones to reach the hive bees, thereby allowing them to accept her as their queen. They are also for ventilation. In one embodiment, the windows 20 are ⅜″× 1/16″. This prevents the queen tarsal pads from going outside the cage 10. It is to be understood, however, that the windows 20 can be any suitable dimensions that prevent the queen tarsal pads from going outside the cage 10.

In one embodiment, an exterior of the cage 10 is made of polyethylene terephthalate (PET) plastic. It is to be understood, however, that the material of the cage 10 can be any suitable material.

In one embodiment, the strap 16 is 7″ long. In other embodiments, any length from about 6″ to 8″ is acceptable.

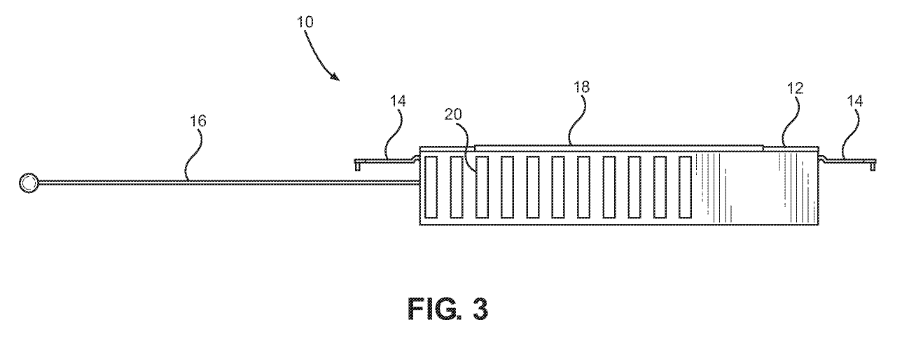

A side view embodiment of the bee transport cage 10 is shown in FIG. 3. To use the cage in one embodiment, the user fills the non-ventilated space within the cage 10 with fondant. He then closes the closes the sliding lid 12. A larger egress door 14 at one end of the cage 10 is closed at the factory. Next, he inserts the queen and her attendants into the smaller egress door 14 at an opposite end of the cage 10 and closes the door. A cross section view of the cage 10 holding a queen bee 22 is shown in FIG. 5.

In one embodiment, to release the queen, the large egress door 14 is opened, and the queen can escape once the fondant is eaten through or is pierced by the beekeeper. In one embodiment, fondant is placed in the cage 10 by the beekeeper for the workers to feed the queen while she is caged. To release her, the large door 14 is opened and the outside bees eat the fondant, thereby releasing the queen. In another embodiment, the beekeeper pierces the fondant allowing the queen to exit. In another embodiment of quick release, the beekeeper slides open the lid, allowing the queen to exit.

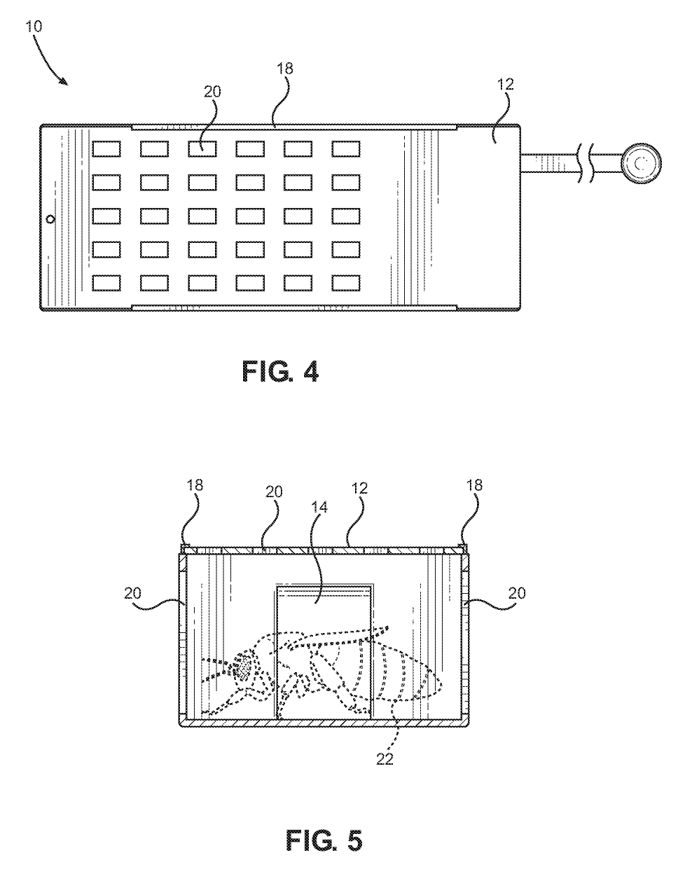

In one embodiment, the strap 16 is utilized when the queen is transported with a package of bees (often about 10,000) that is to become a full beehive. The queen cage is hung by the strap 16 inside the package. This allows the bees to accept her pheromones (scent) and recognize her as their queen. If she were to simply be dropped inside the package prior to being accepted, the bees would cover her, and she would die. A top view of the cage 10 is shown in FIG. 4.

In one embodiment, the strap 16 is simply cut off by the beekeeper or the factory if the queen is being moved without a package in order to save space when shipping multiple queen cages together.

Previous methods include the steps of installing the fondant, stapling the screen wire over the cage opening, putting a cork into one end of the cage, inserting the bees thru a ¼″ hole, placing a second cork into the opposite end hole, stapling a 6″ strap onto the cage for packaging bees, prying up the staples to release, and removing one or both corks. The individual faces the risk of allowing the strap to slip and letting the queen fall into the package of bees. Advantageously, the claimed device eliminates and shortens many of these steps.

Advantageously, the queen cage 10 is only two parts, assembled by the factory or facility producing them. In one embodiment, the cage 10 is manufactured as two injection molded parts; the elongated sliding lid 12 and the base. The factory assembles these parts before delivery to the customer.

In one embodiment, queens with their workers are mailed to a recipient via the USPS inside a cardboard carton.

In additional embodiments, entomologists use the cage to collect insects, keeping the insects alive for study.

It should be understood, of course, that the foregoing relates to exemplary embodiments of the invention and that modifications may be made without departing from the spirit and scope of the invention as set forth in the following claims.

What is claimed is:

1. A device for holding at least one bee comprising:
an elongated sliding lid;
a cage body with a top opening, the elongated lid adapted to slide onto a top of the cage body to seal the top opening of the cage body;
a first egress door at a first end of the cage body; and
a second egress door at a second end of the cage body, the second door being sized to accept the bee into the cage body.

2. The device of claim 1, further comprising an elongated strap attached to the cage body.

3. The device of claim 1, further comprising a plurality of windows on the elongated sliding lid.

4. The device of claim 1, further comprising a plurality of windows on the cage body.

5. The device of claim 1, wherein a space within the cage body includes fondant.

6. The device of claim 1, wherein the cage body is sized to hold at least one bee.

7. The device of claim 1, wherein the elongated lid slides under tracks along the top opening of the cage body to seal the lid.

8. The device of claim 1, wherein the cage body can hold up to five bees.

9. A method of transporting a queen bee in a package of bees with a comprising:
inserting the queen bee into a bee transport cage, the bee transport cage comprising;
an elongated sliding lid;
a cage body with a top opening, the elongated lid adapted to slide onto a top of the cage body to seal the top opening of the cage body;
a first egress door at a first end of the cage body;
a second egress door at a second end of the cage body, the second door being sized to accept the bee into the cage body; and
an elongated strap attached to the cage body.
hanging the bee transport cage by the elongated strap in the package of bees.

10. The method of claim 9, further comprising inserting up to four worker bees into the cage body with the queen bee.
